(19) United States
(12) Patent Application Publication
(10) Pub. No.: US 2014/0279036 A1
(43) Pub. Date: Sep. 18, 2014

(54) AD TARGETING SYSTEM

(71) Applicant: YAHOO! INC., Sunnyvale, CA (US)

(72) Inventors: Mark Ke, San Mateo, CA (US); Wei Zhu, San Jose, CA (US)

(73) Assignee: YAHOO! INC., Sunnyvale, CA (US)

(21) Appl. No.: 13/796,217

(22) Filed: Mar. 12, 2013

(51) Int. Cl. G06Q 30/02

(52) U.S. Cl. CPC G06Q 30/0269
USPC 705/14.66

(57) ABSTRACT

An ad targeting system may provide for determining a prime target based on one or more prime target parameters. The one or more prime target parameters may include criteria for determining a prime target. The criteria for determining a prime target may include one or more of a minimum amount of interactions or associations with individuals and organizations, a minimum amount of notoriety, or a minimum amount of conversions. The system may also provide for deriving a graph data structure based on the prime target and one or more social graph generation parameters. The one or more social graph generation parameters may include criteria for determining targets to link to the prime target. The criteria for determining targets to link to the prime target may include a minimum amount of interactions or associations with prime target.

### 1. FIELD

Example embodiments relate to ad targeting systems, such as ad targeting systems that use information regarding influential audience members.

### 2. BACKGROUND

In 2010, spending on advertising was over one hundred and forty billion dollars in the United States and over four hundred and sixty billion dollars worldwide.¹ In today's media world, ads can be distributed based on demographics and behavior of potential audience members. This can maximize the billions of dollars spent on advertising. ¹“http://www.wpp.com/wpp.press/press/default.htm?guid={23ebd8df-51a5-4a1d-b139-576d711e77ac}”

### BRIEF DESCRIPTION OF THE DRAWINGS

The systems and methods may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a block diagram of an example of a network that can implement an aspect of an example ad targeting system.

FIG. 2 is a block diagram of an example electronic device that can implement an aspect of an example ad targeting system.

FIG. 3 is a flowchart of an example operation that can be performed by an aspect of an example ad targeting system.

FIGS. 4-6 are diagrams of example social graphs that may be defined by respective graph data structures and used as a basis for ad targeting.

### DETAILED DESCRIPTION

Described herein are systems and methods for target advertising that may include an example ad targeting system (ATS). For example, the systems and methods may provide for determining a target audience and/or an ad distribution strategy based on a graph data structure, such as a graph data structure defining a social graph. The graph data structure may be derived from information regarding a prime target and criteria for filtering and organizing the information associated with the prime target. For example, the systems and methods may provide for determining the prime target and deriving a graph data structure based on relationships of the prime target. The systems and methods may also provide for determining a target audience and/or an ad distribution strategy based on such a graph data structure. The systems and methods may also direct the distribution of advertisements based on the graph data structure.

In one example, a processor executing an algorithm receives a prime target, as an input, and generates a graph data structure based on that target. Further, in generating the graph data structure, the processor may facilitate data mining relationships of the target from various source systems using collaborative filtering methods, such as Pearson's similarity index or neural network processes.

In another example, the systems and methods may identify a set of influential members associated with a particular member of a target audience, such as a prime target. Alternatively or additionally, the systems and methods may provide for retrieving a target audience based on demographics, psychographics, and/or behavioral traits, and for filtering out one or more prime targets from the target audience.

FIG. 1 is a block diagram of an example network that can implement the systems and methods, which may include aspects of an example ATS. In FIG. 1, for example, a network 100 may include a variety of networks, e.g., local area network (LAN)/wide area network (WAN) 112 and wireless network 110, a variety of devices, e.g., client devices 101 and 102 and mobile devices 103 and 104, and a variety of servers, e.g., ad targeting requester 107, advertisement server 108, and ATS server 109.

In one example, aspects of the ATS server 109 may provide the determining of the prime target and deriving of the graph data structure based on relationships of the prime target. The ATS server 109 may also provide for the determining of the target audience and/or the ad distribution strategy based on the graph data structure. The ad targeting requester 107 may be any application server, such as an audio/video content server, a web server, an email server, a personal information manager server, and a messaging server, that requests the target audience and/or the ad distribution strategy. Also, the ad targeting requester 107 or another server, such as any application server, may include or be associated with a database or another type of data source that hosts data related to the prime target and other targets. The data related to the prime target, such as data from emails, text messages, calendars, group communications, or social media content associated with the prime target, can be used for the generation of the graph data structure. Also, the ad targeting requester 107 may be, include, and/or be associated with an electronic device, such as a server computer, that can distribute advertisements according to the target audience and/or the ad distribution strategy. Ads for such a distribution may be retrieved from an ad server, such as advertisement server 108. Also, the distributed ads may be viewed from client devices, such as devices 101-104.

A network, e.g., the network 100, may couple devices so that communications may be exchanged, such as the communications of targeted ads between servers, servers and client devices or other types of devices, including between wireless devices coupled via a wireless network, for example. A network may include the Internet, cable networks and other types of television networks, one or more local area networks (LANs), one or more wide area networks (WANs), wire-line type connections, wireless type connections, or any combination thereof. A network may also include mass storage, such as network attached storage (NAS), a storage area network (SAN), and other forms of computer or machine readable media, for example. Such readable media may store the generated graph data structures and algorithms for analyzing and basing ad distribution strategies from the graphs. The readable media may also store algorithms for generating the graph data structures.

In one scenario, a large media provider, such as public social media service or email service, may generate a graph data structure using linear regression algorithms based on social media interactions and emails, for example. The graph data structure may be derived from frequencies of occurrences of these interactions between individuals and/or organizations. The graph data structure may also indicate one or more prime targets, such as targets that historically interact much greater than other individuals and/or organizations or whose interactions are much more successful in obtaining various types of conversions, such as impressions, click-throughs, and purchases. The graph data structure may also indicate one or more individuals and/or organizations that are likely to be influenced by the one or more prime targets. This functionality significantly enhances targeting capabilities by taking advantage of a great sphere of influence usually exhibited by prime targets.

Ad targeting is also enhanced by the systems and methods' abilities to target high volume electronic media users and those that fall either into similar demographics or psychographics, for example, and/or those that are influenced or at least regularly in contact with the high volume electronic media users. The hope is that targeting high volume users will lead to these users influencing others, such as through word of mouth advertising via various forms of media such as phone calls, messaging, electronic and print publications, blogs, and social media content.

FIG. 2 illustrates a block diagram of an example electronic device 200 that can implement aspects of the methods and systems, such as an aspect of an example ATS. Instances of the electronic device 200 may include servers, such as servers 107-109. In general, the electronic device 200 can include a processor 202, memory 210, a power supply 206, and input/output components, such as a network interface(s) 230, a user input/output interface(s) 240, and a communication bus 204 that connects the aforementioned elements of the electronic device. The network interface(s) 230 can include a receiver and a transmitter (or a transceiver), and an antenna for wireless communications. The processor 202 can be one or more of any type of processing device, such as a central processing unit (CPU). Also, for example, the processor 202 can include hardware, firmware, software and/or combinations of each to perform a function(s) or an action(s), and/or to cause a function or action from another component. The memory 210, which can include RAM 212 or ROM 214, can be enabled by one or more of any type of memory device, such as a primary (directly accessible by the CPU) and a secondary (indirectly accessible by the CPU) storage device (e.g., flash memory, magnetic disk, or optical disk). The RAM can include an operating system 221, data storage 224, and applications 222, including ATS software 223. The ROM can include BIOS 220 of the electronic device 200. The power supply 206 contains one or more power components and facilitates supply and management of power to the electronic device 200. The input/output components can include any interfaces for facilitating communication between any components of the electronic device 200, components of external devices (such as components of other devices of the network 100) and end users. Also, the I/O interfaces can include user interfaces such as monitors, keyboards, touchscreens, microphones, and speakers. Further, some of the I/O interfaces and the bus 204 can facilitate communication between components of the electronic device 200, and can ease processing performed by the processor 202.

Where the electronic device 200 is a server, it can include a computing device that is capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set-top boxes, integrated devices combining various features, such as two or more features of the foregoing devices, or the like.

The server may be an application server that may include a configuration to provide an application, such as an aspect of an ATS, via a network to another device. Also, an application server may host a website that can provide an end user and/or administrative user interface for the ATS. Examples of content provided by the abovementioned applications, including an aspect of the ATS, may include text, images, audio, video, or the like, which may be processed in the form of physical signals, such as electrical signals, or may be stored in memory as physical states.

An example ATS may include one or more computers, such as a server, operable to receive an ad targeting request from a requester. The computer(s) may also be operable to determine a prime target based on one or more first parameters of the ad targeting request. The computer(s) may also be operable to derive a graph data structure based on the prime target and one or more second parameters of the ad targeting request. The computer(s) may also be operable to determine a target audience list and/or an ad distribution strategy based on the graph data structure. The computer(s) may also be operable to send the target audience list and/or the ad distribution strategy to the requester.

FIG. 3 illustrates a flowchart of an example method that can be performed by one or more aspects of the ATS, such as the electronic device 200 (method 300). The method 300 may include receiving an ad targeting request determining a prime target based on parts of the ad targeting request, and deriving a graph data structure based on the prime target and parts of the ad targeting request. The parts of the ad targeting request may include information regarding a prime target and/or criteria for filtering and organizing the information associated with the prime target.

The criteria for filtering and organizing the information may include interaction types, media types for carrying out interactions, geographic proximity criteria, domain types (such as Internet domain types), shared interests, types of social relationships, timing criteria (such as timing based on events), and market trends, for example. In one scenario, the information associated with the prime target may be filtered by a timing criteria based on an event, such as a school reunion. A social graph for a school reunion may include links representing friendships and nodes representing alumni of the school. In another example, filtering by market trends may include filtering a target group out of a target audience based on their likeliness to purchase a certain product or service, such as life insurance. A social graph for life insurance advertising may include links representing interaction types between targets, such as phone calls or emails, and nodes representing anyone likely to buy life insurance. The prime target, which is represented by a node that other nodes may branch off, may include an individual or group of individuals that are even more likely to buy life insurance. In such a scenario, the prime target may be based on a market trend (such as new parents are likely to purchase life insurance), and/or based on behavioral traits, such as the prime target being one or more individuals that purchase an abnormally large amount of insurance policies.

In one example, the graph data structure may be based on the prime target's types of associations with individuals and/or organizations, and/or based on the prime target's geographic distance from individuals and/or organizations. A geographic distance may be determined with respect to a prime target's current location, residence, or workplace location, for example. A location of a prime target may be retrieved via an Internet Protocol address of a device frequently used by the target.

The prime target may be one or more individuals, such as one influential person or an influential group of people sharing a demographic, psychographic, and/or behavioral trait. The prime target may also be one or more organizations, such as for-profit or not-for-profit organizations. Examples organizations include schools, government agencies, businesses, and the like.

A processor (e.g., the processor 202) can perform the method 300 by executing processing device readable instructions encoded in memory (e.g., the memory 210). The instructions encoded in memory may include a software aspect of the system, such as the ATS software 223.

The method 300 may include an interface aspect of an electronic device (e.g., the network interface(s) 230 or the user input/output interface(s) 240) receiving an ad targeting request from a requester (at 302). The requester may be one or more user, such as one or more employees at an advertising firm, or one or more electronic devices, such as server computers serving various forms of electronic media content. Electronic media may include applications, web content, social media content, email, messaging (voice and/or text), streaming or downloadable audio/video content, and interactive media such as video games. The ad targeting request may include various parameters, such as prime target parameters and social graph generation parameters.

At 304, a processing aspect (e.g., the processor 202) may determine a prime target based on one or more prime target parameters of the ad targeting request. Prime target parameters include parameters representing criteria for identifying and determining prime targets. Criteria for identifying and determining prime targets may include a minimum amount of interactions with others by the target, such as a minimum amount of emails sent and/or received, calls made, voice or text messages sent and/or received, and/or social media interactions, for example. Criteria for identifying and determining prime targets, when the targets include one or more people, may include a minimum amount of associations with individuals and organizations, such as a minimum amount of contacts, friends, family, fellow alumni, co-workers, and memberships to groups or organizations. Criteria for identifying and determining prime targets, when the targets include one or more organizations, may include a minimum amount of associations with individuals and organizations as well, such as a minimum amount of contacts, supporters, alumni, staff, and members. Such criteria may also include a minimum amount of notoriety of the target, such as a minimum amount of fame, occurrences referenced in widely distributed printed and/or electronic publications, television, radio, and recorded media. Criteria for identifying and determining prime targets may also include a minimum amount of conversions by the target, such as a minimum purchasing frequency and frequency of clicking on advertisements.

At 306, the processing aspect may derive a graph data structure (such as one of the graphs depicted in FIGS. 4-6), based on the prime target and one or more social graph generation parameters of the ad targeting request. For example, in autumn before the November and December holidays, an ad targeting request for gift sales may be received by the processing aspect in order to target individuals with large amounts of friends and family. From this request, a graph data structure may be derived based on a prime target with a large amount of friends and family. This graph data structure may be generated to show the friends and family connections, which may lead to discovery of more prime targets with large amounts of friends and family.

Social graph generation parameters may include parameters representing criteria for selecting nodes of the graph data structure, such as nodes of a prime target and targets associated with the prime target. Social graph generation parameters may also include parameters representing criteria for limiting and organizing the graph data structure. The criteria for limiting or organizing the graph data structure may be determined by the requester or given to the requester by another party, such as an advertisement agency. The ad targeting request may also include parameters for interpreting the graph data structure and for directing advertisements to targets, such as directing advertisements based on the interpretation of the graph data structure.

Criteria for identifying and determining nodes representing targets, such as prime target nodes and related target nodes, may be similar to the criteria for identifying and determining prime targets, since a prime target node represents a prime target in a graph and related target nodes represents individuals or organizations associated with the prime target or that share similar qualities. Such criteria may also include limitation on the number of nodes selected. For example, degree of separation can be limited, such as limiting related target nodes to fourth degree relationships. In FIG. 4, for example, related target node 8A has a fourth degree relationship with prime target A. Nodes selected may also be determined categorically by type of association with a prime target node. For example, in FIGS. 4-6, nodes representing targets associated with a prime target are selected by their type of association with a prime target or related targets.

Criteria for organizing and limiting nodes of the graph data structure may include a number of dimensions to be included in the graph data structure. For example, the graph data structure can be one dimension where links of the graph represent only interaction types (such as types of communication mediums) between targets (e.g., see graphs of FIG. 4). The graph may also be multidimensional, such that links of the graph may represent interaction types, social relationships, and other types of associations between targets (e.g., see graphs of FIGS. 5 and 6). General organization of the graph may also include limiting degrees of connections with respect to a prime target. In this regard, a related target node of a graph data structure may have multiple degrees of separation with respect to a prime target node (e.g., see graphs of FIGS. 4-6). For example, a graph data structure is two degrees where it includes terminal nodes representing targets, one level of intermediate nodes representing targets, and at least one prime target node in which the other nodes branch off.

Criteria for organizing and limiting nodes may also include setting limitations on selecting nodes and setting whether link lengths adjust depending on a strength of association between two connected nodes. In FIG. 4, for example, the links vary in length according to strength of association between nodes. For example, the link between related targets 5A and 7A is much stronger than the connection between prime target A and related target 1A.

In one example, the graph data structure may reflect strength in associations between targets. Strength in associations may be represented by lengths of links between nodes of the graph data structure. For example, the shorter the length of a link between two nodes the stronger the association between the two nodes. Also, a number of degrees of separation between two nodes may represent strength in associations between targets. A maximum distance permitted from the prime target node may be set manually or automatically using data mining techniques such as linear regression or neural network techniques. Using a maximum distance parameter in the generation of the graph data structure ensures that the generated graph data structure is finite. Given this, the maximum distance may be decreased to limit the size of the graph data structure. This functionality may be useful where processing resources are limited.

Criteria for organizing the graph data structure may also include whether to allow for more than one type of connection between two nodes. For example, in FIG. 4, prime target A has five links with related target 3A and one link with related target 1A.

Criteria for organizing and limiting nodes may also include how to filter the related nodes with respect to the prime target node and/or what type of target nodes are allowed at varying degrees of separation with respect to the prime target node. For example, in FIG. 5, the graph is filtered in general by types of social relationships between related targets and the prime target, but in a third degree link between related target 5B and related target 7B, a link has occurred by a frequent type of interaction between the two nodes. In this case, the nodes are filtered by whether they have a social relationship with the prime target or another target, but at the third degree link, a connection can be made by a frequent type interaction. FIG. 6 illustrates an example graph where the categorical types of connections between nodes differ per degree of separation relative to the prime target C. In FIG. 6, the first degree associations are by hobby, the second degree associations are by occupation or municipality of residence, the third degree associations are by whether a target enjoys or frequents the theatre, and the fourth degree associations are by demographic, such as similar age and sex of the targets. As imaginable, there are many categorical types of links and different types of links may be more beneficial for varying types of products or services to advertise. For example, one type of connection could be based on geographic distance between a current location of a prime target and a related target. Such links may be useful if a product or service relates to the prime target's current location and needs to be purchased immediately.

At 308, the processing aspect may determine a target audience list and/or an ad distribution strategy based on the graph data structure. Also, at 310, the processing aspect may send the target audience list and/or the ad distribution strategy to the requester, for example. A target audience list may include every node included on the graph data structure or be limited by a link degree, for example, such as fourth degree of separation from the prime target. In FIG. 4, for example, under such settings every node of the graph would be included on the list, since it appears to be limited to fourth degree links from the prime target.

Regarding a distribution strategy, the processing aspect may analyze the graph data structure and make recommendations based on trends in the graph represented by the data structure, such as connection trends. For example, one strategy determined from a social graph may be to target alum of a particular school, since such alum of the particular school may tend to be friends, family, and/or coworkers (e.g., see FIG. 5). Also, for example, a generated social graph may provide information to an already determined ad distribution strategy. For example, for a strategy to target individuals with large amounts of friends and families during Christmas, a generated social graph may illustrate which individuals to target.

With respect to variations of generated social graphs, which may be defined by corresponding graph data structures, FIGS. 4-6 provide some examples. In FIGS. 4-6, a length of a link between two nodes represents a quantity and/or quality of interactions between two connected nodes, and each link represents a type of association between each node. As mentioned, a node represents one or more target audience members, which may be one or more individuals or organizations.

In FIG. 4, related targets have been selected by the type and amount of interaction they have had with the prime target A or related targets. For example, in this figure, an email link between two nodes may represent that targets of the two nodes have communicated via email at a determined frequency above a threshold. Where the link is shorter, such as in the case of the link from prime target A to related target 2A being shorter than the link from prime target A to target 1A, a greater determined frequency of emails have been exchanged between the targets of the nodes. Also, in this figure, a contact link between two nodes may represent that a node of the two connected nodes is a contact of the other node. Identifying of such a contact may occur by querying data of a personal information manager of a target, for example. A social media link between two nodes may represent that that targets of the two nodes interact via social media at a determined frequency above a threshold. A call and messaging link between two nodes may represent that targets of the two nodes have communicated via phone calls or messaging at determined frequencies above threshold, respectively.

In FIG. 5, related targets have been selected by their social relationships and amount of interaction with the prime target B or related targets. For example, in this figure, a family link between two nodes may represent individuals that are related familially and interact electronically at a determined frequency above a threshold. Also, in this figure, a friend link between two nodes may represent individuals that are friends and interact electronically at a determined frequency above a threshold, for example. A co-worker link between two nodes may represent current or past co-workers who interact electronically at a determined frequency above a threshold, for example. An alum link between two nodes may represent alumni of an organization, such as alumni of a school or business, who interact electronically at a determined frequency above a threshold, for example. A household link between two nodes may represent members of a household, or current or past roommates, for example. Other links shown relate targets by mutual club membership or an occupation, for example. Additionally, besides relating targets by their social relationships, targets in the graph of FIG. 5 may also be linked by a type of interaction, when the link is three degrees from the prime target B (e.g., see the link between related targets 5B and 7B).

In FIG. 6, related targets have been selected by demographics or psychographics, for example, and an amount of interaction they have had with the prime target C or related targets. Additionally, in this figure, each degree represents different types of demographic or psychographic connections. For example, in this figure, the first degree from the prime target C includes links representing mutual hobbies. The second degree links may represent mutual occupations or places of residence. The third degree connections represent a preference for theatre, such as a determined frequency of ticket purchases above a threshold, for example. The fourth degree links may represent shared demographics, such as being the same sex and being within a same age range. Additionally, shown in this figure and in FIGS. 4 and 5, is an open ended link aimed towards three dots. This link represents that the depicted graphs may include other nodes not depicted. Also, such a depiction may represent a user interface element of a graphical user interface (GUI) that allows a user to expand a respective graph displayed by the GUI.

While various embodiments of the systems and methods have been described, it will be apparent to those of ordinary skill in the art that many more embodiments and implementations are possible within the scope of the systems and methods. Accordingly, the systems and methods are not to be restricted except in light of the attached claims and their equivalents.

Subject matter may be embodied in a variety of different forms, and therefore, covered or claimed subject matter is intended to be construed as not being limited to any example set forth herein. Examples are provided merely to be illustrative. Among other things, for example, subject matter may be embodied as methods, devices, components, or systems. Accordingly, subject matter may take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. The terminology used in the specification is not intended to be limiting of examples of the invention. In general, terminology may be understood at least in part from usage in context. For example, terms, such as “and”, “or”, or “and/or”, as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Likewise, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

It will be further understood that the terms “comprises”, “comprising”, and/or “including” when used herein, specify the presence of stated features, integers, steps, operations, elements, and/or components, but do not preclude the presence or addition of one or more other features, integers, steps, operations, elements, components, and/or groups thereof, and in the following description, the same reference numerals denote the same elements.

We claim:

1. A system, comprising:
memory that includes processor executable instructions; and
a processor connected to the memory and the interface, the processor configured to execute the instructions to:
determine a prime target based on one or more prime target parameters, the prime target being an individual, an organization, a group of individuals, or a group of organizations, the one or more prime target parameters including criteria for determining a prime target, the criteria for determining a prime target including one or more of a minimum amount of interactions or associations with individuals and organizations, a minimum amount of notoriety, or a minimum amount of conversions; and
derive a graph data structure based on the prime target and one or more social graph generation parameters, the one or more social graph generation parameters including criteria for determining targets to link to the prime target, the criteria for determining targets to link to the prime target including a minimum amount of interactions or associations with prime target.

2. The system of claim 1, where the processor is configured to execute the instructions to determine a target audience list based on the graph data structure.

3. The system of claim 2, comprising an interface configured to receive an ad targeting request from a requester, where the ad targeting request includes the one or more prime target parameters and the one or more social graph generation parameters, and where the processor is configured to execute the instructions to send, via the interface, the target audience list to the requester.

4. The system of claim 1, where the processor is configured to execute the instructions to determine an ad distribution strategy based on the graph data structure.

5. The system of claim 4, comprising an interface configured to receive an ad targeting request from a requester, where the ad targeting request includes the one or more prime target parameters and the one or more social graph generation parameters, where the processor is configured to execute the instructions to send, via the interface, the ad distribution strategy to the requester.

6. The system of claim 1, comprising an interface configured to receive an ad targeting request from a requester, where the ad targeting request includes a group of targets sharing a demographic, a psychographic, or a behavioral trait, and where the processor is configured to execute the instructions to select the prime target from the group of targets.

7. An electronic device implemented method, comprising:
determining, by a processor, a prime target based on one or more prime target parameters of an ad targeting request, the prime target being an individual, an organization, a group of individuals, or a group of organizations, the one or more prime target parameters including criteria for determining a prime target, the criteria for determining a prime target including one or more of a minimum amount of interactions or associations with individuals and organizations, a minimum amount of notoriety, or a minimum amount of conversions;
deriving, by the processor, a graph data structure based on the prime target and one or more social graph generation parameters of the ad targeting request, the one or more social graph generation parameters including criteria for determining targets to link to the prime target, the criteria for determining targets to link to the prime target including a minimum amount of interactions or associations with prime target; and
determining a target audience list or an ad distribution strategy based on the graph data structure.

8. The method of claim 7, comprising receiving, at the processor, the ad targeting request from a requester.

9. The method of claim 7, comprising sending, by the processor, the target audience list or the ad distribution strategy to the requester.

10. The method of claim 7, where the ad targeting request includes a group of targets sharing a demographic, and where the processor is configured to execute the instructions to select the prime target from the group of targets.

11. The method of claim 7, where the ad targeting request includes a group of targets sharing a psychographic, and where the processor is configured to execute the instructions to select the prime target from the group of targets.

12. The method of claim 7, where the ad targeting request includes a group of targets sharing a behavioral trait, and where the processor is configured to execute the instructions to select the prime target from the group of targets.

13. An electronic device implemented method, comprising:
receiving, at a processor, a group including one or more of individuals and organizations;
selecting, by the processor, a prime target from the group based on one or more prime target parameters, the prime target being an individual, an organization, a group of individuals, or a group of organizations, the one or more prime target parameters including criteria for determining a prime target, the criteria for determining a prime target including one or more of a minimum amount of interactions or associations with individuals and organizations, a minimum amount of notoriety, or a minimum amount of conversions; and
deriving, by the processor, a graph data structure based on the prime target and one or more social graph generation parameters, the one or more social graph generation parameters including criteria for determining targets to link to the prime target, the criteria for determining targets to link to the prime target including a minimum amount of interactions or associations with prime target.

14. The method of claim 13, comprising determining, by the processor, a target audience list based on the graph data structure.

15. The method of claim 14, comprising transmitting, via an interface communicatively coupled to the processor, the target audience list to an external electronic device.

16. The method of claim 13, comprising determining, by the processor, an ad distribution strategy based on the graph data structure.

17. The method of claim 16, comprising transmitting, via an interface communicatively coupled to the processor, the ad distribution strategy to an external electronic device.

18. The method of claim 13, comprising transmitting, via an interface communicatively coupled to the processor, the graph data structure to an external electronic device.

19. The method of claim 13, where a link of the graph data structure varies in length according to a strength of an association between two corresponding nodes of the graph.

20. The method of claim 13, where the graph data structure is multidimensional.
